(19) United States
(12) Patent Application Publication
(10) Pub. No.: US 2014/0352199 A1
(43) Pub. Date: Dec. 4, 2014

(54) Animal Trap

(71) Applicant: Mike Loyd Matney, Cattle Falls, WA (US)

(72) Inventor: Mike Loyd Matney, Cattle Falls, WA (US)

(21) Appl. No.: 13/905,000

(22) Filed: May 29, 2013

(51) Int. Cl. A01M 23/02; A01M 23/16

(52) U.S. Cl. CPC A01M 23/02; A01M 23/16
USPC 43/61

(57) ABSTRACT

Generally, an animal trap floatable in a body of water having an entry enclosure defining an entry opening having a trap door which by operation of a door latch including a door trip element and a door set element rotates about a door pivot axis between a set-closed condition and a tripped-open condition allowing an animal lured by a bait in a bait station to fall through a trap floor into an interior chamber defined by apertured walls of a container allowing serial capture of plurality of animals.

### I. FIELD OF THE INVENTION

Generally, an animal trap floatable in a body of water having an entry enclosure defining an entry opening having a trap door which by operation of a door latch including a door trip element and a door set element rotates about a door pivot axis between a set-closed condition and a tripped-open condition allowing an animal lured by a bait in a bait station to fall through a trap floor into an interior chamber defined by apertured walls of a container allowing serial capture of a plurality of animals.

### II. BACKGROUND OF THE INVENTION

Animal traps are used to catch animals for relocation or for euthanasia.

A wide variety of traps are known for trapping animals out of water; however, fewer traps are known which are floatable on a body of water. One difficulty in providing a trap floatable in a body of water for trapping more than one animal such as muskrats can be to provide a float adjustable in relation to the trap entry to establish the water level at a height in relation to the trap door to position the door trip element at a height trippable by an animal.

Additionally, most traps have a structure which allows only one animal to be trapped at one time. The trapped animal must then be removed and the trap reset before another animal can be caught with the trap. Particular configurations of resetting traps are known for use on land. Such traps typically included a trap door located on top of a cage, and a trigger mechanism that automatically resets itself after each animal drops into the cage. Trap that reset for use on land traps used in are disclosed in U.S. Pat. No. 2,763,092 issued to Sheridan, U.S. Pat. No. 2,733,541 issued to McKim, U.S. Pat. No. 2,163,577 issued to Allen, U.S. Pat. No. 1,856,980 issued to Weaver, U.S. Pat. No. 1,810,608 issued to Jacobs, and U.S. Pat. No. 1,798,717 issued to Baranski. However, it can be difficult to provide a reliable structure for a resetting trap for capture of more than one animal when the animal trap floats in a body of water in capture of a plurality of animals.

Moreover, most traps include a cage for holding a trapped animal, and a trigger mechanism designed to be tripped by an animal to cause a door to close behind the animal after it enters the cage. However, these animal traps allow the capture of only one animal at a time. The trapped animal must then be removed and the trap reset before another animal can be caught with the trap.

### III. SUMMARY OF THE INVENTION

Accordingly, a broad object of the invention can be to provide an animal trap floatable in a body of water for the group capture of animals which provides a float configured to establish water level at a height in relation to an entry enclosure to provide a door trip element at a location trippable by an animal. As to particular embodiments, the float can further include a float height adjustment element which allows adjustment of the float in relation to the entry enclosure to provide buoyancy to float the animal trap in a body of water with a water level medially located between the entry bottom and the entry top to provide a door trip element at a location trippable by an animal.

Another broad object of the invention can be to provide a trap door rotationally coupled proximate the entry bottom of an entry enclosure with the trap door rotating about a trap door pivot axis between a set-closed condition and a tripped-open condition and having a door latch rotationally coupled to the trap door at location between a door trip element and a door set element to dispose said door trip element and said door set element on opposed sides of the trap door disposing the door set element in contact with the entry bottom and the door trip element in a position trippable by contact of an animal entering said entry enclosure in said set-closed condition of said trap door and which resets without human intervention between capture of each of a plurality of animals.

Another broad object of the invention can be to provide a trap floor located between the trap door and a bait station which allows ingress of the animal into a container and prevents egress of said animal from the container to the entry enclosure and resets without human intervention allowing serial capture of a plurality of animals even when floated in a body of water.

### IV. BRIEF DESCRIPTION OF THE DRAWINGS

FIG. 1 is an illustration of a particular embodiment of the inventive animal trap floatable in a body of water.

FIG. 2 is a front view of a particular embodiment of the inventive animal trap.

FIG. 3 is back view of a particular embodiment of the inventive animal trap.

FIG. 4 is a first side view of a particular embodiment of the inventive animal trap.

FIG. 5 is top view of a particular embodiment of the inventive animal trap.

FIG. 6 is a bottom view of a particular embodiment of the inventive animal trap.

FIG. 7 is a cross section view 7-7 of the particular embodiment of the inventive animal trap shown in FIG. 3

FIG. 8 is a partial cross section view 8-8 of the particular embodiment of the inventive animal trap shown FIG. 3 which illustrates a method of using the inventive animal trap.

FIG. 9 is a partial cross section view 9-9 of the particular embodiment of the inventive animal trap shown FIG. 3 which illustrates a method of using the inventive animal trap.

### V. DETAILED DESCRIPTION OF THE INVENTION

Generally, an animal trap (1) floatable in a body of water (2) having an entry enclosure (3) defining an entry opening (4) having a trap door (5) which by operation of a door latch (6) including a door trip element (7) and a door set element (8) rotates about a door pivot axis (9) between a set-closed condition (10) and a tripped-open condition (11) allowing an animal (12) lured by a bait (13) in a bait station (14) to fall through a trap floor (15) into an interior chamber (16) defined by apertured walls (17) of a container (18).

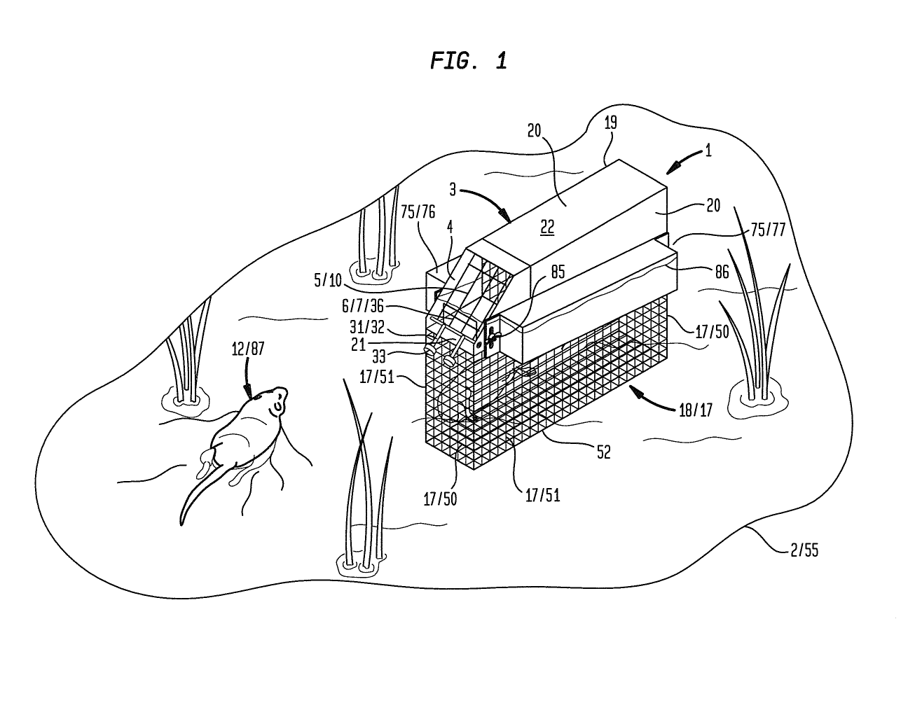

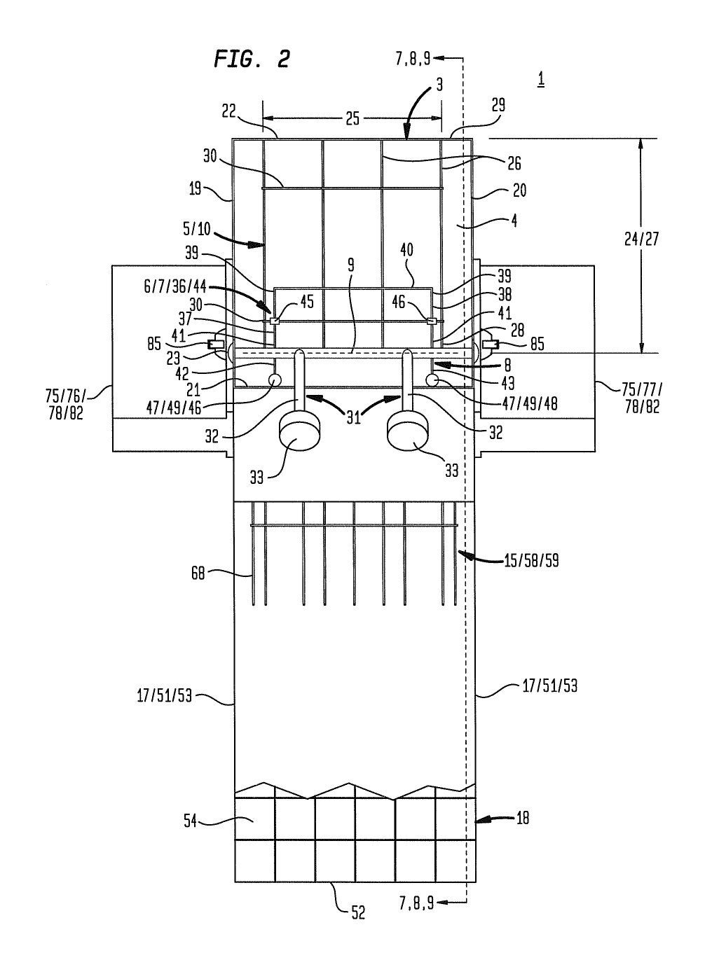

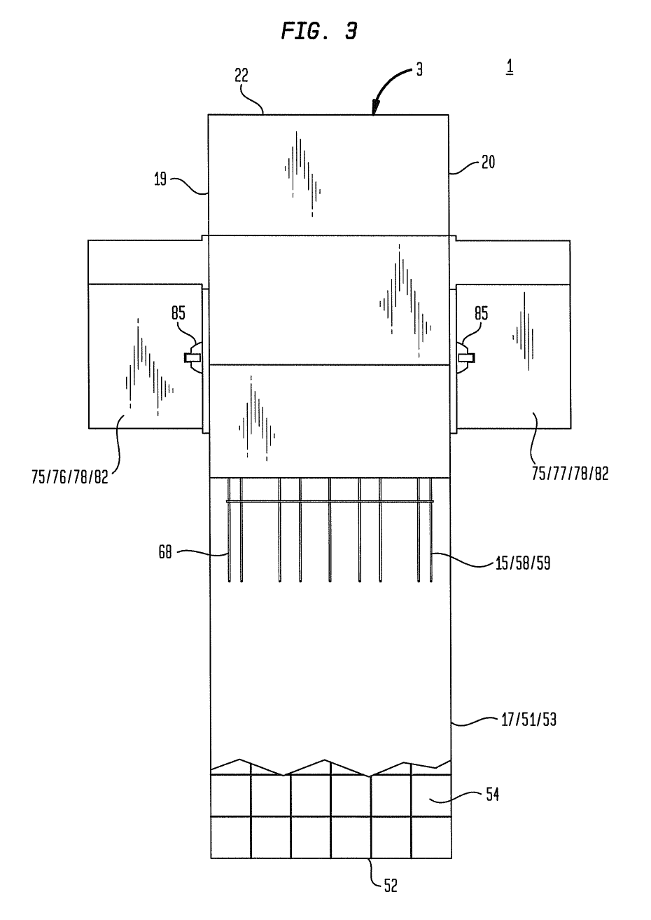

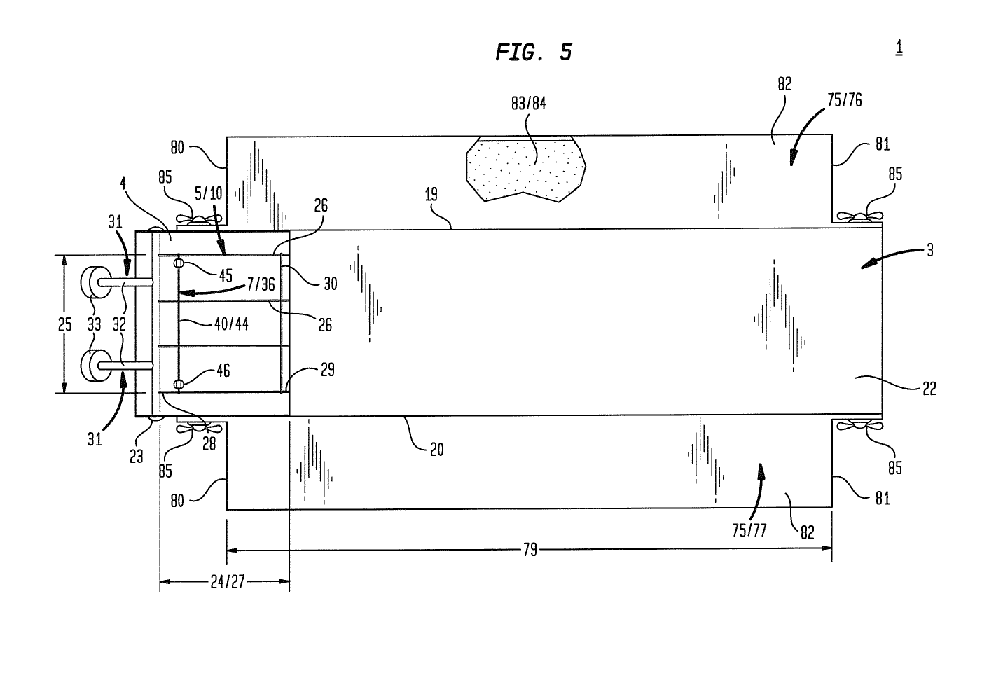

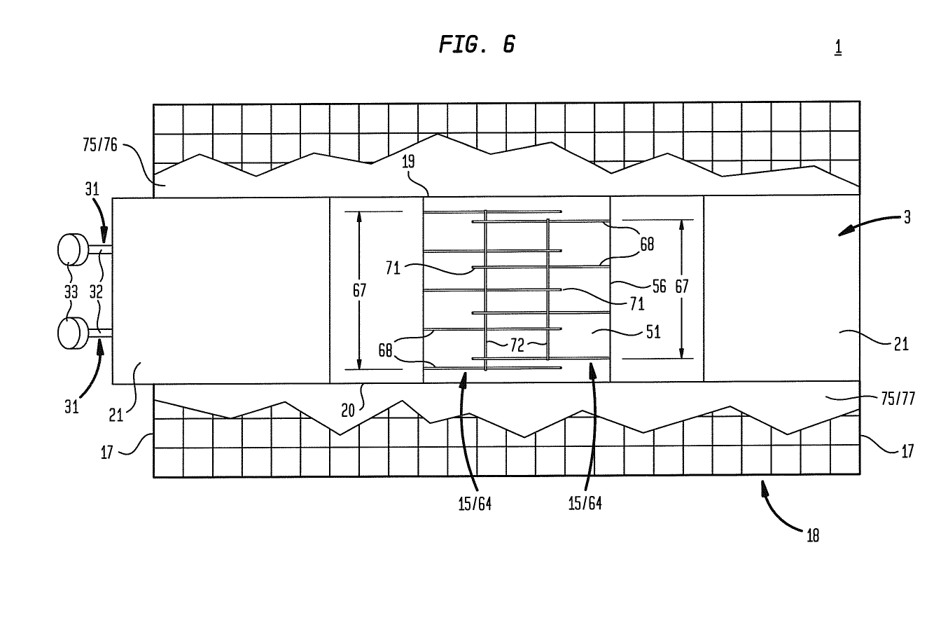

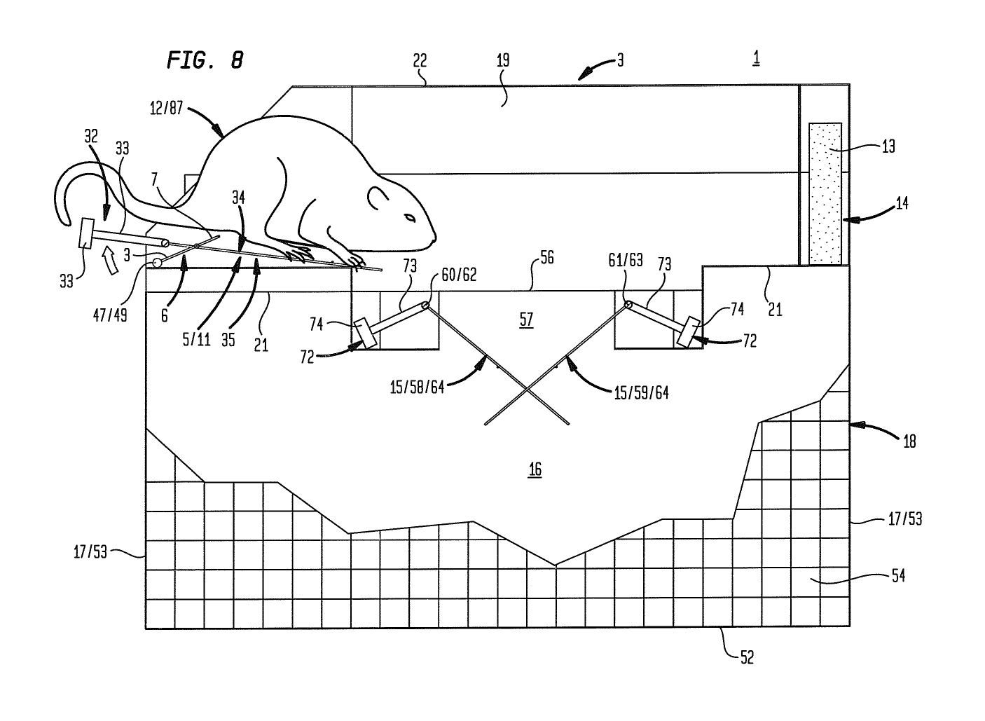

Now referring primarily to FIGS. 1 through 7, embodiments of the invention include an entry enclosure (3) having a pair of entry sides (19)(20) connecting an entry bottom (21) and an entry top (22). The entry enclosure (3) defines an entry opening (4) for a trap door (5). A door pivot element (23) can be disposed between the pair of entry sides (19)(20) proximate the entry bottom (21). The trap door (5) can be connected to or rotationally coupled to the door pivot element (23) allowing the trap door (5) to rotate about the door pivot element axis (9) between a set-closed condition (10)(as shown in the examples of FIGS. 1 and 2) and a tripped-open condition (11) (as shown in the example of FIG. 8).

The entry enclosure (3) can be produced from a wide variety of materials; and while the entry enclosure (3) shown in the figures is produced from cut and bent thin sheet metal; the invention is not so limited, and embodiments of the entry enclosure (3) can otherwise be produced from plastics such as polypropylene, polyethylene, polyvinylchloride; composite materials including layers of laminatable material which can include fibers which can be the same, similar, or different in the same piece or between pieces of laminatable material such as boron carbide, silicon carbide, alumina, alumina titanium, carbon, KEVLAR®, INEGRA®, DYNEEMA®, SPECTRA®, s-glass, e-glass, or the like, which can be impregnated with an amount of resin such as phenolic, epoxy, polyethylene terephtalate, vinylester, polyimides, bismaleimide/diallybisphenol A, cyanate esters, thermoplastics, polypropyelene, nylon, or the like, to bond the layers together under pressure, or similar materials or combinations thereof

The trap door (5) can be have a trap door height (24) and a trap door width (25) sufficient in dimension to prevent egress of an animal (12) through the entry opening (4) in the set-closed condition (10). Typically, the trap door (5) can be produced from an apertured material which enables the animal (12) to see and smell a bait (13) placed in a bait station (14) within the entry enclosure (3) distal from the trap door (5). A particular embodiment of the trap door (5) can be produced from a plurality of spaced apart wire members (26) each having a member length (27) disposed between a wire member first end (28) connected to or rotationally coupled to a door pivot element (23) and a wire member second end (29) terminating at the trap door height (24). A plurality of wire cross members (30) can be connected across the plurality of wire members (26) to reinforce the trap door (5). However, it is not intended that this illustrative example be limiting with respect to the numerous wide variety of apertured or unapertured materials that can be utilized to produce the trap door (5) such as perforated materials, screen mesh, sheet metal, or the like; or can be used to fabricate an apertured material such as wires, rods, cable stretched between frame members, or the like.

Again referring primarily to FIGS. 1 through 7, the trap door (5) can further include a door counter balance (31) coupled to said trap door (5) which by action of gravity moves the trap door (5) toward the set-closed condition (10). In the embodiment shown in the figures, one or more elongate door counter balance members (32) extend outwardly from the door pivot element (23) and terminate in a door counter balance weight (33). The elongate door counter balance members (32) have sufficient length responsive to sufficient mass of the door counter balance weight (33) to move the trap door (5) toward the set-closed condition (10). While the illustrative example of FIGS. 1 through 7, include a pair of cylindrical elongate door counter balance members (32) and a corresponding pair of cylindrical door counter balance weights (33); the invention is not so limited, and the door counter balance (31) can be of any configuration which acts under influence of gravity to move the trap door (5) from a tripped open-condition (11) toward a set-closed condition (10).

Again referring primarily to FIGS. 1-2, 5, and 7 through 9, the trap door (5) can further include a door latch (6) having a door trip element (7) trippable by contact of the animal (12) entering the entry enclosure (3) allowing the trap door (5) to move toward the tripped-open condition (11) for ingress of an animal into the entry enclosure (3), and a door set element (8) which upon return of the trap door (5), whether by action of the door counter balance (31) or otherwise, maintains the trap door (5) in the set-closed condition (10) to prevent egress of the animal (12) from the entry enclosure (3).

Now referring primarily to FIGS. 1, 2 and 7, an embodiment of the door latch (6) rotationally couples to the trap door (5) at location between the door trip element (7) and the door set element (8) to dispose the door trip element (7) and the door set element (8) on opposed exterior and interior door sides (34)(35) of the trap door (5). The door latch (6) can rotate to dispose the door set element (8) in contact with the entry bottom (21) to maintain the trap door (5) in the set-closed condition (10) and position the door trip element (7) in a trippable condition (36) by contact of an animal (12) entering the entry enclosure (3) seeking the bait (13) in the bait station (14). An embodiment of the door trip element (7) includes a pair of side members (37)(38) having a pair of first ends (39) connected by a crosspiece (40) and a pair of second ends (41) rotatably coupled to the trap door (5). A corresponding pair of door set members (42)(43) each rotationally responsive to movement of the door trip element (7) can extend from the pair of side members (37) on the interior side (35) of the trap door (5). The door trip element (7) can extend outwardly from the exterior side (34) of the trap door (5) and the door set element (8) can extend inwardly from the interior side (35) of the trap door (5). In the set-closed condition (10) of the trap door (5), the door trip element (7) triggerable by contact of an animal (12) extends outward from the exterior side (34) of the trap door (5) and the door set element (8) engages the entry bottom (21). As to the illustrative examples shown in the Figures, the pair of side members (37)(38) and the crosspiece (40) and the pair of door set members (42)(43) can be produced as a one-piece bent wire (44) with a pair of tubular couplers (45)(46) correspondingly coupled to the second ends (41) of the door trip element (7) and rotatably coupled to one of the plurality of wire cross members (30) of the trap door (5).

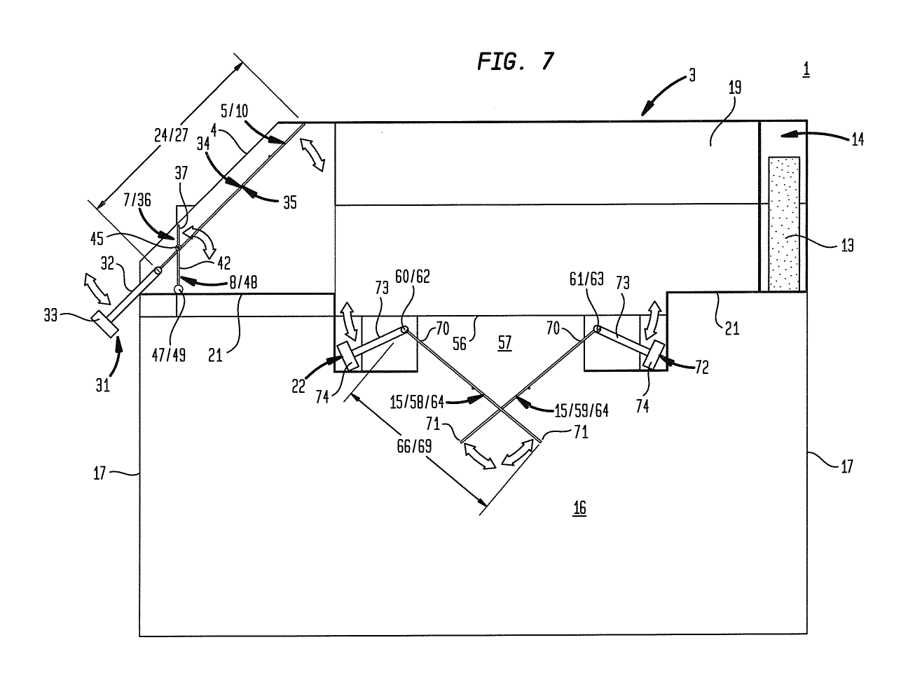

Now referring primarily to FIG. 7, embodiments can further include a door latch counter balance (47) coupled to the door set element (8) which by influence of gravity moves the door set element (8) to a set position (48) with the door latch counter balance (47) contacting the entry bottom (21) to provide the set-closed condition (10) of the trap door (5). As to particular embodiments, the door latch counter balance (47) can be configured as a pair of spherical elements (49) correspondingly coupled to the pair of door set elements (8). The pair of spherical elements (49) having sufficient mass under influence of gravity to move the door set elements (8) to the set position (48).

Now referring primarily to FIGS. 1, 4 and 7, the entry enclosure (3) can be secured above a container (18) having apertured walls (17) defining an interior chamber (16).

Embodiments of the container (18) can have a generally rectangular configuration including two pairs of interconnected generally parallel vertical container side walls (50)(51) and a container bottom (52) formed of a mesh screen (53) which defines the configuration of the volume of the interior chamber (16). The mesh screen (53) can have screen openings (54) sufficient in open area to allow ingress of water (55) and insufficient in open area to allow egress of an animal (12) from within the interior chamber (16).

Typically, the mesh screen (53) will be produced from a metal mesh screen; however, the container side walls (50)(51) and container bottom (52) can be produced in a wide variety of configurations to which a correspondingly configured entry enclosure (3) can be secured above to define the interior chamber (16) which can have the volume of a cube, rectangle, cylinder, pyramid, cone or the like depending upon the application, and can be made from a wide variety of suitable apertured materials such as, a woven wire openwork, expanded sheet metal, perforated sheet metal, polymeric material, wood, reed, or the like. As to particular embodiments, the container walls (50)(51) can be discrete interconnected pieces or the general shape of the container (18) can be made from one sheet of apertured material provided with four 90 degree bends to form the container bottom (52) and the container side walls (50)(51). The container side walls (50)(51) can be connected by any suitable method, such as by welding, mechanical fasteners, or other method known by those skilled in the art.

Again referring primarily to FIGS. 1, 4 and 7, the entry enclosure (3) secured above the container (18) can provide the entry bottom (21) in a faun extending between the trap door (5) and the bait station (14). The entry bottom (21) can further include an entry bottom aperture element (56) defining an entry bottom opening (57) communicating between the entry enclosure (3) and the interior chamber (16) of the container (18). The entry bottom opening (57) can have a sufficient area to allow an animal (12) ingress from the entry enclosure (3) into the interior chamber (16) of the container (18). As to particular embodiments, a trap floor (15) positioned in relation to said entry bottom aperture element (56) can be configured to allow ingress of an animal (12) into the interior chamber (16) of the container (18) but prevent egress of the animal (12) from the interior chamber (16) of the container (18).

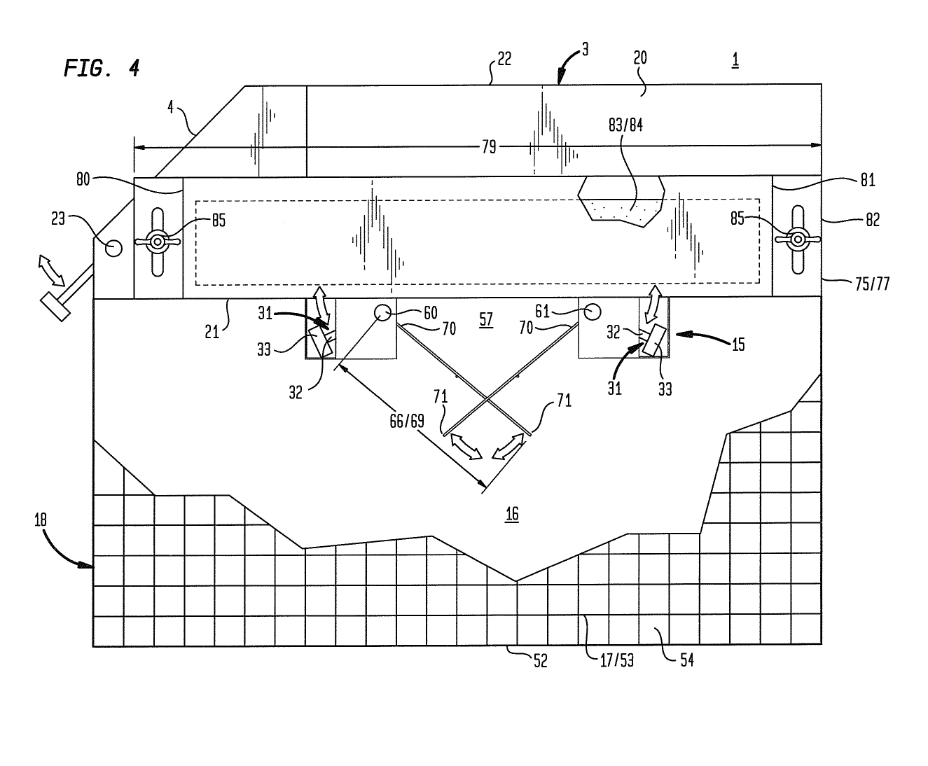

Now referring primarily to FIGS. 4, 6 and 7, which show an illustrative example of a trap floor (15) including a trap floor first portion (58) and a trap floor second portion (59) corresponding connected to or rotationally coupled to a pair of trap floor pivot elements (60)(61) allowing corresponding rotation about a pair trap floor axes (62)(63) between a trap floor closed condition (64) which disposes the trap floor first portion (58) and the trap floor second portion (59) in proximity to prevent egress of the animal from the interior chamber (16) of the container (18), and a trap floor open condition (65) which disposes the trap floor first portion (58) and the trap floor second portion (59) a sufficient distance apart to allow ingress of the animal (12) into the interior chamber (16) of the container (18).

The trap floor first portion (58) and the trap floor second portion (59) can each have a trap floor length (66) and a trap floor width (67) sufficient in dimension to prevent egress of an animal (12) through the entry bottom opening (57) in the trap floor closed condition (64). The trap floor first portion (58) and the trap floor second portion (59) be produced in similar manner to the trap door (5) from a plurality of spaced apart wire floor members (68) each having a floor member length (69) disposed between a wire floor member first end (70) connected to or rotationally coupled to a trap floor pivot element (60) or (61) and a wire floor member second end (71) terminating at the trap floor length (69). A plurality of wire floor cross members (72) can be connected across the plurality of wire members (68) to reinforce the trap floor (15). However, it is not intended that this illustrative example be limiting with respect to the numerous wide variety of apertured or unapertured materials that can be utilized to produce the trap floor (15) such as perforated materials, screen mesh, sheet metal, or the like; or can be used to fabricate an apertured material such as wires, rods, cable stretched between frame members, or the like.

Now referring primarily to FIG. 7, the trap floor (15) or each of a trap floor first portion (58) and trap floor second portion (59) can further include a trap floor counter balance (72) coupled to the trap floor (15) or each of the trap floor first and second portions (58)(59) which under influence of gravity moves the trap floor (15) toward the trap floor closed condition (64). In an illustrative embodiment, one or more trap floor elongate counter balance members (73) extend outwardly from each trap floor pivot element (60)(61) and terminate in a trap floor counter balance weight (74). The trap floor elongate counter balance members (73) have sufficient length responsive to sufficient mass of the trap floor counter balance weight (74) to move the trap floor (15) or each of the first and second trap floor portions (58)(59) toward the trap floor closed condition (64). While the illustrative example of FIG. 7, includes a pair of cylindrical trap floor elongate counter balance members (73) and a corresponding pair of trap floor cylindrical counter balance weights (74); the invention is not so limited and the trap floor counter balance (72) can be of any configuration which acts under influence of gravity to move the trap floor (15) from a trap floor open condition (65) toward a trap floor closed condition (64).

Now referring primarily to FIGS. 1 through 5, embodiments of the inventive animal trap (1) can further include a float (75) configured to provide sufficient buoyancy to float the animal trap (1) in a body of water (2) with a water level (86) medially located between the entry bottom (21) and the entry top (22)(as shown in the example of FIG. 1). As to particular embodiments, the float (75) can be configured as a pair of floats (76)(77) disposed on opposed entry sides (19)(20) of the entry enclosure (3). As shown in the example of FIG. 1, the pair of floats (76)(77) can each be configured as a generally elongate rectangular float member (78) having a float length (79) disposed between a float first end (80) coupled proximate the trap door (5) and a float second end (81) coupled distal from the trap door (5). The float (75) or the pair of floats (76)(77) can be produced as a float housing (82) defining a float interior chamber (83), a float housing filled with a foam material (84), or substantially a foam material (84) without a float housing (82). The foam material (84) can as examples be one or more of a polystyrene foam, a polyurethane foam, or similar foam material.

The float (75) or pair of floats (76)(77) can further include a float height adjustment element (85) which allows the float (75) or pair of floats (76)(77) to be height adjusted in relation to the entry enclosure (3) to correspondingly adjust buoyancy of the animal trap (1) in a body of water (2) to correspondingly adjust a water level (86) in relation to the entry enclosure (3). As to the particular embodiment of the pair of floats (76)(77) shown in the illustrative example of FIG. 1, each of the pair of floats (76)(77) can have a float first end (80) and a float second end (81) with one or both float ends height adjustable to distribute buoyancy to float the animal trap (1) in a body of water (2) with the water level (86) between the entry bottom (21) and the entry top (22). While the float height adjustment element (85) shown in the figures provides slotted float ends through which a mechanical fastener passes to releasably secure each of the pair of floats (76)(77); other embodiments of the invention may include other forms of float height adjustment elements (85) such as ties, cord, multiple perforations through which a mechanical fastener passes to adjustably secure each float (76)(77) to the entry enclosure (3), or the like.

Now referring to primarily to FIGS. 1, 8 and 9, which illustrate a method of using embodiments of the inventive animal trap (1) to trap an animal (12) such as a muskrat (87);

however, certain inventive elements of the animal trap (1) can be utilized in a wide variety of animal traps (1) whether floated or otherwise disposed for the capture of other types of animals. An amount of bait (13) can be located in a bait station (14) within the entry enclosure (3). By influence of gravity on the trap floor counter balance (72) the trap floor (15), or first and second trap floor portions (58)(59) move to the trap floor closed condition (64). Similarly, by influence of gravity the trap door counter balance (31) moves the trap door (5) to the set-closed condition (10) and the door latch counter balance (47) moves the door set element (8) to the set position (48) and moves the door trip element (7) to the trippable condition (36).

Now referring primarily to FIG. 1, the animal trap (1) can be floated on a body of water (2) with the water level (86) established between the entry bottom (21) and the entry top (22) with the container (1) submerged below the water level (86). The float (75) or the pair of floats (76)(77) can be height adjusted to establish the water level (86) between the entry bottom (21) and the entry top (22).

Now referring primarily to FIG. 8, an animal (12) contacts the door trip element (7) which rotates trip element (7) and the door set element (8) disengaging the door set element (8) from the entry bottom (22) allowing the trap door (5) to move toward the tripped-open condition (11) allowing the animal (12) lured by the bait (13) in the bait station (14) ingress into the entry enclosure (3).

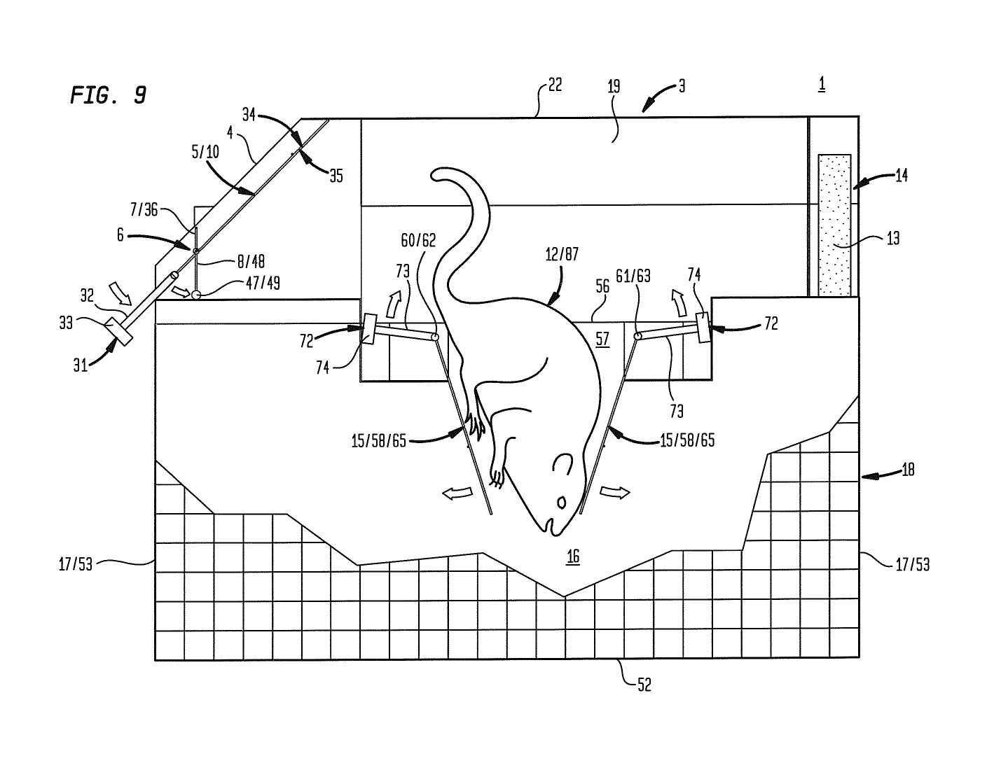

Now referring primarily to FIG. 9, the animal (12) lured by the bait (13) in the bait station (14) falls through the entry bottom opening (57). The trap floor (15) or the trap floor first and second portions (58)(59) by contact of the animal (12) move(s) toward the trap floor open condition (65) allowing the animal (12) to fall into the interior chamber (16) of the container (18). By influence of gravity on the trap floor counter balance (72) moves the trap floor (15) or trap floor first and second portions (58)(59) to the trap floor closed condition (64) preventing egress of the animal (12) from the container (18). Similarly, by influence of gravity the trap door counter balance (31) moves the trap door (5) to the set-closed condition (10) and the door latch counter balance (47) moves the door set element (8) to the set position (48) and positions the door trip element (7) in the trippable condition (36). Accordingly, the animal trap (1) can serially capture a plurality of animals (12) without manual intervention to re-establish the animal trap in the set-closed condition (10).

As can be easily understood from the foregoing, the basic concepts of the present invention may be embodied in a variety of ways. The invention involves numerous and varied embodiments of an animal trap and methods for making and using the animal trap including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “trap” should be understood to encompass disclosure of the act of “trapping”—whether explicitly discussed or not—and, conversely, were there effectively disclosure of the act of “trapping”, such a disclosure should be understood to encompass disclosure of a “trap” and even a “means for trapping.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the animal traps herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An animal trap, comprising:
a container having apertured walls defining an interior chamber;
an entry enclosure having a pair of entry sides connecting an entry bottom and an entry top, said entry enclosure defining an entry opening in said container;
a trap door rotationally coupled proximate said entry bottom, said trap door rotating about a trap door pivot axis between a set-closed condition and a tripped-open condition; and
a door latch having a door trip element and a door set element, said door latch rotationally coupled to said trap door at location between said door trip element and said door set element to dispose said door trip element and said door set element on opposed sides of said trap door, said door set element in contact with said entry bottom and said door trip element trippable by contact of an animal entering said entry enclosure in said set-closed condition of said trap door.

2. The animal trap of claim 1, further comprising a door latch counter balance coupled to said door set element which under influence of gravity moves said door set element to a set position in said set-closed condition of said trap door.

3. The animal trap of claim 2, wherein said door trip element includes a pair of side members having a pair of first ends connected by a cross piece and a pair of second ends rotatably coupled to said trap door, and wherein said door set element includes a pair of door set members each rotationally responsive to rotation of said door trip element.

4. The animal trap of claim 3, wherein said door latch counter balance couples to at least one of said pair of door set members.

5. The animal trap of claim 4, further comprising a door counter balance coupled to said trap door which by action of gravity moves said trap door to said set closed condition.

6. The animal trap of claim 1, wherein said entry bottom extends over said container.

7. The animal trap of claim 6, further comprising a bait station having a location in said entry enclosure distal from said trap door.

8. The animal trap of claim 7, further comprising a floor opening in said entry bottom having a location between said trap door and said bait station.

9. The animal trap of claim 8, further comprising a trap floor positioned in relation to said floor opening configured to allow ingress of said animal into said container and prevents egress of said animal from said container.

10. The animal trap of claim 9, wherein said trap floor includes a first trap floor portion and a second trap floor portion having a corresponding pair of trap floor first ends which rotate about a corresponding pair trap floor axis between trap floor closed condition which disposes a corresponding pair of trap floor second ends in proximity to prevent egress of said animal from said container and a trap floor open condition which allows ingress of said animal into said container.

11. The animal trap of claim 1, further comprising a float coupled to said animal trap, said float configured to provide buoyancy to float said animal trap in a body of water with a water level medially located between said entry bottom and said entry top.

12. The animal trap of claim 11, wherein said float comprises a pair of floats disposed on opposed sides of said entry enclosure.

13. The animal trap of claim 12, wherein each float comprises an elongate member having a length disposed between a float first end coupled proximate said trap door and a float second end coupled distal from said trap door, and wherein said float first end height adjustable in relation to said float second end to provide buoyancy to float said to float said animal trap in a body of water with a water level medially located between said entry bottom and said entry top.

14. An animal trap, comprising:
a container having apertured walls defining an interior chamber;
an entry enclosure having a pair of entry sides connecting an entry bottom and an entry top, said entry enclosure defining an entry opening in said container;
a trap door rotationally coupled proximate said entry bottom, said trap door rotating about a trap door pivot axis between a set-closed condition and a tripped-open condition;
a float coupled to said animal trap, said float configured to provide buoyancy to float said animal trap in a body of water with a water level medially located between said entry bottom and said entry top; and
a float height adjustment element which allows adjustment of said float in relation to said entry enclosure to provide buoyancy to float said to float said animal trap in a body of water with a water level medially located between said entry bottom and said entry top.

15. The animal trap of claim 14, wherein said float comprises a pair of floats disposed on opposed sides of said entry enclosure.

16. The animal trap of claim 15, wherein each of said pair of floats comprises an elongate member having a length disposed between a float first end coupled proximate said trap door and a float second end coupled distal from said trap door, and wherein said float height adjustment element allows height adjustment of said float first end in relation to a said float second end to provide buoyancy to float said to float said animal trap in a body of water with a water level medially located between said entry bottom and said entry top.

17-26. (canceled)

27. An animal trap, comprising:
a container having apertured walls defining an interior chamber;
an entry enclosure having a pair of entry sides connecting an entry bottom and an entry top, said entry enclosure defining an entry opening in said container, said entry bottom extending over said container;
a trap door rotationally coupled proximate said entry bottom, said trap door rotating about a trap door pivot axis between a set-closed condition and a tripped-open condition;
a floor opening in said entry bottom having a location between said trap door and a bait station having a location on said entry bottom distal from said trap door; and
a trap floor positioned in relation to said floor opening, said trap floor including a first trap floor portion and a second trap floor portion having a corresponding pair of trap floor first ends which rotate about a corresponding pair trap floor axis to dispose a corresponding pair of trap floor second ends between a trap floor closed condition which prevents egress of said animal from said container and a trap floor open condition which allows ingress of said animal into said container.

28. The animal trap of claim 27, further comprising a door latch having a door trip element and a door set element, said door latch rotationally coupled to said trap door at location between said door trip element and said door set element to dispose said door trip element and said door set element on opposed sides of said trap door, said door set element in contact with said entry bottom and said door trip element trippable by contact of an animal entering said entry enclosure in said set-closed condition of said trap door.

29. The animal trap of claim 28, further comprising a door latch counter balance coupled to said door set element which by action of gravity moves said door set element to a set position in said set-closed condition of said trap door.

30-31. (canceled)

32. The animal trap of claim 29, further comprising a door counter balance coupled to said trap door which by action of gravity moves said trap door said set closed condition.

33-35. (canceled)
